(19) United States
(12) Patent Application Publication
(10) Pub. No.: US 2008/0080114 A1
(43) Pub. Date: Apr. 3, 2008

(54) Apparatus, systems and methods for reliably detecting faults within a power distribution system

(75) Inventors: Edmund O. Schweitzer, Pullman, WA (US); Veselin Skendzic, Pullman, WA (US); Gregary C. Zweigle, Pullman, WA (US); Robert E. Morris, Viola, ID (US); Andrew A. Miller, Moscow, ID (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(73) Assignee: Schweitzer Engineering Laboratories, Inc.

(21) Appl. No.: 11/540,252

(22) Filed: Sep. 29, 2006

(51) Int. Cl. H02H 3/00

(52) U.S. Cl. 361/62

(57) ABSTRACT

A line disturbance detector is disclosed which oversees the operation of power protection devices monitoring the same conductor, and only allows a power automation or control operation when both the disturbance detector and a traditional power protection device, such as a protection relay, determine such an operation is required.

### CROSS-REFERENCE TO RELATED APPLICATIONS

None

1. Field of the Invention

The present invention relates generally to apparatus, systems, and methods for power protection, and more specifically, to apparatus, systems, and methods for validating decision making mechanisms within a power protection system.

2. Description of the Prior Art

Power transmission and distribution networks require an extremely high degree of reliability. Failures in such systems can lead to blackouts. Electrical switchgear, such as circuit breakers and reclosers, are deployed in power networks to isolate faults while maintaining power to as many end users as possible. Usually, a digital intelligent electronic device, such as a relay or recloser control, controls the operation of electrical switchgear. However intelligent electronic devices are susceptible to errors caused by background radiation. In particular, memory components used within intelligent electronic devices are susceptible to bit errors caused by high energy particles such as neutrons or alpha particles.

A number of techniques have been disclosed in the prior art detailing methods for reducing errors caused by radiation and other unpredictable sources of errors. For instance, U.S. Pat. No. 6,886,116, issued to Christopher MacLellan, discloses a system for validating error detection logic in a data storage system. MacLellan utilizes a plurality of fault injectors to create erroneous conditions, and then utilizes additional logic to ensure that the error detection logic picks up on the error and does not interfere with the normal operation of the device. MacLellan is a good example of an error detection technique applied to a combined hardware/software system.

U.S. Pat. No. 6,594,774, issued to Craig Chapman and Mark Moeller, focuses exclusively on software errors. In addition to other techniques, Chapman applies the concept of a watchdog timer to individual software processes. A watchdog timer is a hardware timer coupled to a microprocessor that must be reset within a given time period or the watchdog timer causes the microprocessor to reset. In Chapman, individual executable fibers (i.e.; threads or processes) register with a watchdog thread. The executable fibers must then notify the watchdog thread periodically, or the watchdog thread takes a containment action, such as terminating the thread.

Many techniques suited to other industries are not necessarily well suited to the power protection industry. Power protection devices often operate in hostile environments, with large amounts of electromagnetic radiation present. Historically, the power protection industry has dealt with this problem through the use of shielding, grounding, and other basic mechanical and electrical techniques, as well as readback validation of memory structures. Given the sensitivity of the power grid to failures, there is a continuing need within the power protection industry to devise techniques to further reduce the failures of power protection devices and thereby improve the reliability of the power grid.

### OBJECTS OF THE INVENTION

Accordingly, it is an object of this invention to provide reliable power system automation and control capable of detecting and correcting a large percentage of would-be failures, and thereby raising the overall reliability of the power grid.

Another object of this invention is to provide a system for reliably identifying and isolating faults in a monitored power line with fault detection logic that can, in a large percentage of cases, detect when it has erroneously detected a fault, and prevent the system from taking adverse action based on the erroneously detected fault.

Yet another object of this invention is to provide a disturbance detector for supervising the operation of a primary fault detector.

### SUMMARY OF THE INVENTION

The disclosed invention achieves its objectives through the use of a disturbance detector, which oversees the operation of power protection devices monitoring the same conductor. The “disturbance detector” may be a separate device, or it may be additional logic provided within a relay, recloser control, or other intelligent electronic device within the power distribution system.

In one embodiment, where the disturbance detector is a separate device, a trip operation is only allowed when both the disturbance detector and a traditional power protection device, such as a protection relay, detect a fault on the monitored power conductor. This is accomplished through the use of a trip bus connected to the contacts of the traditional power protection device, so that the traditional power protection device cannot cause a line breaker to open unless the trip bus is energized. The trip bus is only energized when the disturbance detector detects a fault on the monitored conductor. Therefore, both the disturbance detector and the traditional power protection device must detect a fault before a trip can occur, isolating the monitored conductor.

In a separate embodiment, the disturbance detector is implemented as additional logic within an intelligent electronic device. An analog to digital converter samples a line parameter related to a power conductor. A first logical processor comprised of one or more physical processors processes the line parameter samples and executes a fault detection algorithm which produces a fault output. A second logical processor does the same. A logic block examines the fault outputs of both logical processors and outputs a trip signal based on the fault outputs.

This invention may also be implemented as a method for reliably detecting and isolating faults in a power conductor. The disturbance detector, whether it is a separate device or additional logic in a single device, monitors the power conductor for faults and energizes a trip bus when it detects a fault. In addition, a power protection device also monitors the same power conductor and operates its contacts, which will only cause a trip operation to isolate the power conductor if the trip bus has been energized.

### BRIEF DESCRIPTION OF THE DRAWINGS

Although the characteristic features of this invention will be particularly pointed out in the claims, the invention itself, and the manner in which it can be made and used, can be better understood by referring to the following description taken in connection with the accompanying drawings forming a part hereof, wherein like reference numerals refer to like parts throughout the several views and in which:

FIG. 1 is a diagram of a power protection system utilizing a disturbance detector to oversee other power protection devices.

FIG. 2 is a functional block diagram of one embodiment of the disclosed disturbance detector.

FIG. 3 is an illustration of a preferred fault detection algorithm of the disclosed disturbance detector.

FIG. 4 is a functional block diagram of a disturbance detector implemented using additional logic within an intelligent electronic device.

FIG. 5 is a functional block diagram showing one way that a disturbance detector could be implemented across multiple components within an intelligent electronic device.

### DETAILED DESCRIPTION OF THE ILLUSTRATED EMBODIMENTS

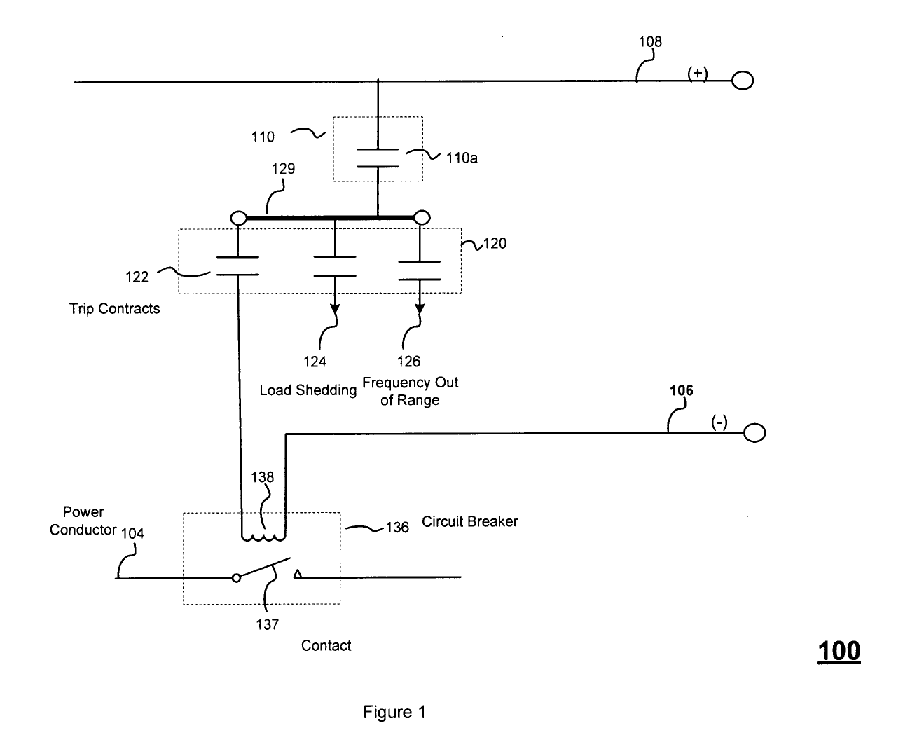

Referring to the Figures, and in particular to FIG. 1, a power protection system 100 utilizing a disturbance detector 110 is illustrated. The power protection system 100 could be located in a switching station or some other appropriate site. A pair of DC terminals 106 and 108 provides power to protective devices at the site, such as the disturbance detector 110 and the protective relay 120.

As illustrated, the disturbance detector 110 oversees the operation of the protective relay 120. The trip and control contact pairs of the protective relay 120 are wired so that one contact of each pair is wired together to form a trip bus 129. The contacts 110a of the disturbance detector 110 are wired so that only if the disturbance detector's 110 contacts are closed is the trip bus 129 energized; i.e.; brought to the potential of the positive DC terminal 108. As opposed to dry contacts, a semiconductor device could conceivably be used to energize the trip bus. The protective relay 120 has multiple contacts, with each set of contacts performing a specific function. As pictured, the protective relay 120 has trip contacts 122, load shedding contacts 124, and frequency-out-of-range contacts 126. Circuit breaker 136 has a coil 138 which controls contacts 137, which are closed when the coil is not energized. One end of the coil 138 is wired to the trip contacts 122 of the protective relay 120, and, as illustrated, the other end of the coil 138 is wired to the negative DC terminal 106. When the coil 138 of the circuit breaker 136 is energized, the contacts 137 open, which will isolate power conductor 104 in conjunction with a remote circuit breaker (not pictured).

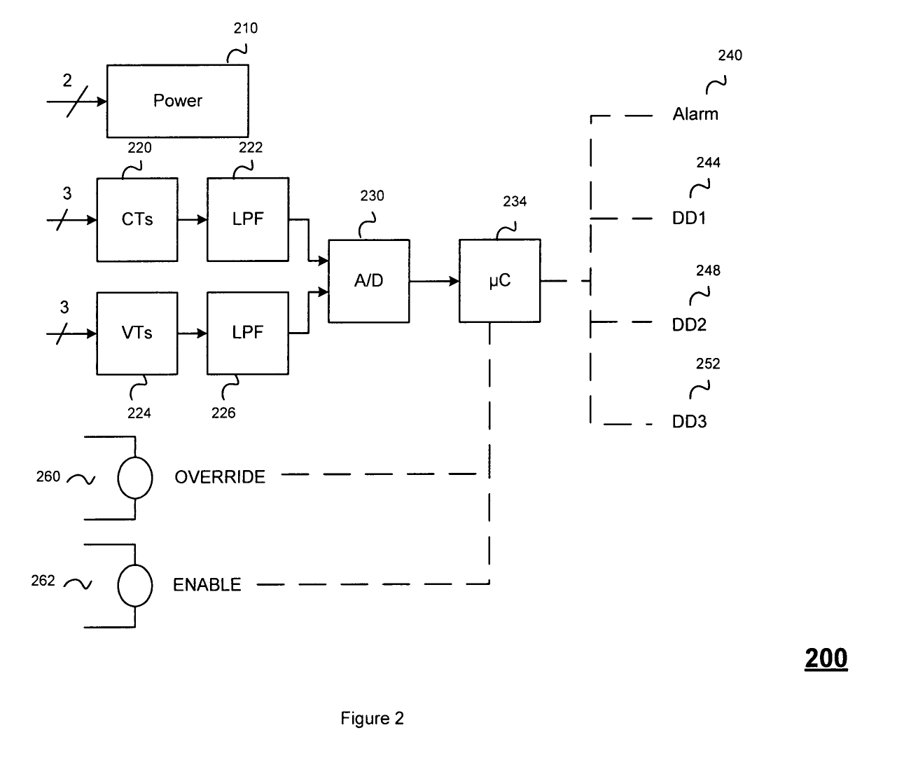

FIG. 2 illustrates the functional blocks of the disclosed disturbance detector 200. DC power source 210, which may be the DC bus present at a power protection site, provides power for the disturbance detector 200. Three current transformers 220 and voltage transformers 224 monitor a three phase power distribution line (not shown) and acquire corresponding current signals and voltage signals. Each phase of the monitored current signals pass through a low pass filter 222, which frequency limits the acquired current signals to a range suitable for use by the analog to digital converter 230. Similarly, each phase of the acquired voltage signals also pass through a low pass filter 226 before being converted to digital form by the analog to digital converter 230. The microcontroller 234 operates on the acquired digital current and voltage signals and determines if a fault is present on any of the three monitored phases.

FIG. 2 also illustrates the possibility that the disturbance detector 200 includes multiple contacts 240, 244, 248, and 252. The multiple contacts may include an alarming contact 240, and other contacts 244, 248, and 252. The other contacts may be used, for example, for multiple phases, or multiple functions such as load shedding, frequency-out-of-range, and the like. The contacts may be wired in the normally-closed position so that a failure in the bus would be energized in the event that the disturbance detector 200 fails.

Further, there may be two further inputs to the disturbance detector 200 for override 260 and enable 262. The override 260 option would force all contacts to close, and the enable 262 option would prevent any contacts from closing.

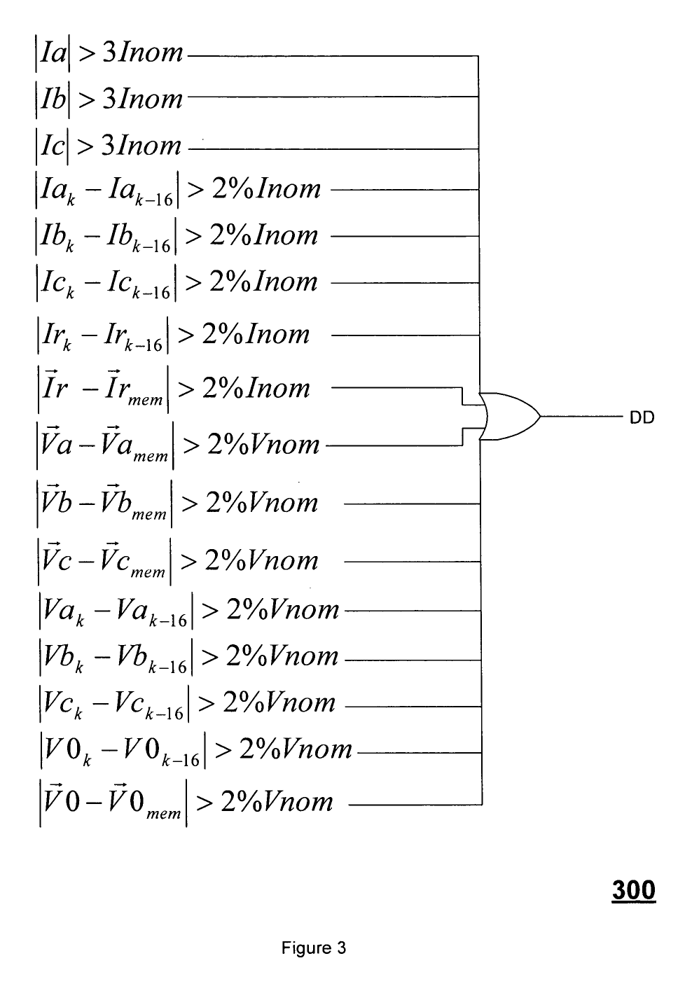

FIG. 3 illustrates the preferred fault detection algorithm 300 used by the disturbance detector 200 of FIG. 2, although other prior art fault detection algorithms could be utilized within the principles of this invention. As illustrated, a fault determination is made for any phase if (i) the RMS current calculated based on the most recently taken sample of any phase is greater than three times the nominal RMS current, (ii) the most recent RMS current calculation differs by more than 2% from the RMS current calculation made based on the sample taken 16 sampling periods (or 1 cycle assuming a sampling frequency of 16 samples per cycle) earlier in any of the phases, (iii) the most recent residual current calculation differs by more than 2% from the residual current calculation performed based on the sample taken 16 sampling periods earlier, (iv) the most recent residual current calculation differs by more than 2% from the memorized residual current calculation, (v) the calculated RMS voltage applied to any phase differs by more than 2% from the memorized RMS voltage, (vi) the most recently calculated RMS voltage in any phase differs by more than 2% from the RMS voltage calculation made 16 sampling periods earlier, (vii) the most recently calculated RMS zero sequence voltage differs more than 2% from the RMS zero sequence voltage calculated based on the sample taken 16 sampling periods earlier in any of the phases, or (viii) the zero sequence RMS voltage calculated based on the most recent sample differs by more than 2% from the zero sequence RMS voltage calculated based on the sample taken 16 sampling periods earlier. In the described algorithm, memorized refers to a specific calculated value taken a predetermined time period earlier; i.e.; 1 second previous, etc.

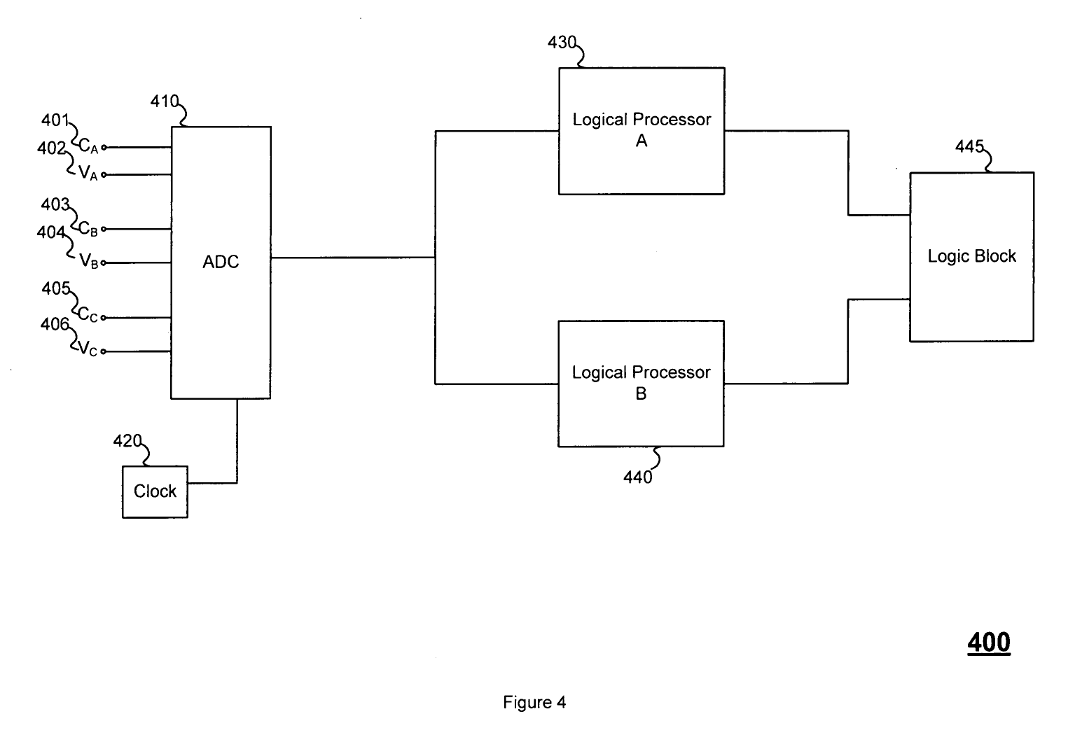

FIG. 4 illustrates an intelligent electronic device 400 utilizing additional logic to implement an internal disturbance detector. Three phases of current and voltage are acquired as analog signals 401-406 and converted into digital form by analog to digital converter 410. Note that acquisition of both voltage and current are not required for robust fault detection algorithms, and are shown here as only one possible implementation of the invention that executes the fault detection algorithm shown in FIG. 3. Analog to digital converter 410 periodically samples different channels of information under the control of clock 420. The clock 420 is representative of a synchronizing mechanism and can be implemented using one of multiple approaches. For example a crystal, or a control mechanism arising from a processor which includes one or all of logical processor A 430, logical processor B 440, and logic block 445. The sampled data is then processed by two separate logical processors, denoted as 430 and 440 in FIG. 4.

Logical processor A 430 and logical processor B 440 may be implemented using the same physical processor, separate identical physical processors, or separate and different physical processors. If logical processor A 430 and logical processor B 440 are implemented using the same physical processor, then they represent two separate programs using two separate areas of memory. In any case, logical processor A 430 and logical processor B 440 may execute the same algorithm, but are not required by the disclosed invention to do so. Further, if logical processors 430 and 440 are implemented using separate physical processors, they each may implement certain parts of their executed algorithms across the separate physical processors. Both logical processors produce a fault output, which is examined in logic block 445. Logic block 445 can be configured to produce a trip signal if both logical processors 430 and 440 indicate a fault for added security, or it can be configured to produce a trip signal if either logical processor 430 or 440 indicates a fault for redundancy. Note that the principles shown here could be extended to more than two logical processors. Similarly, a single logical processor could operate across more than two physical processors.

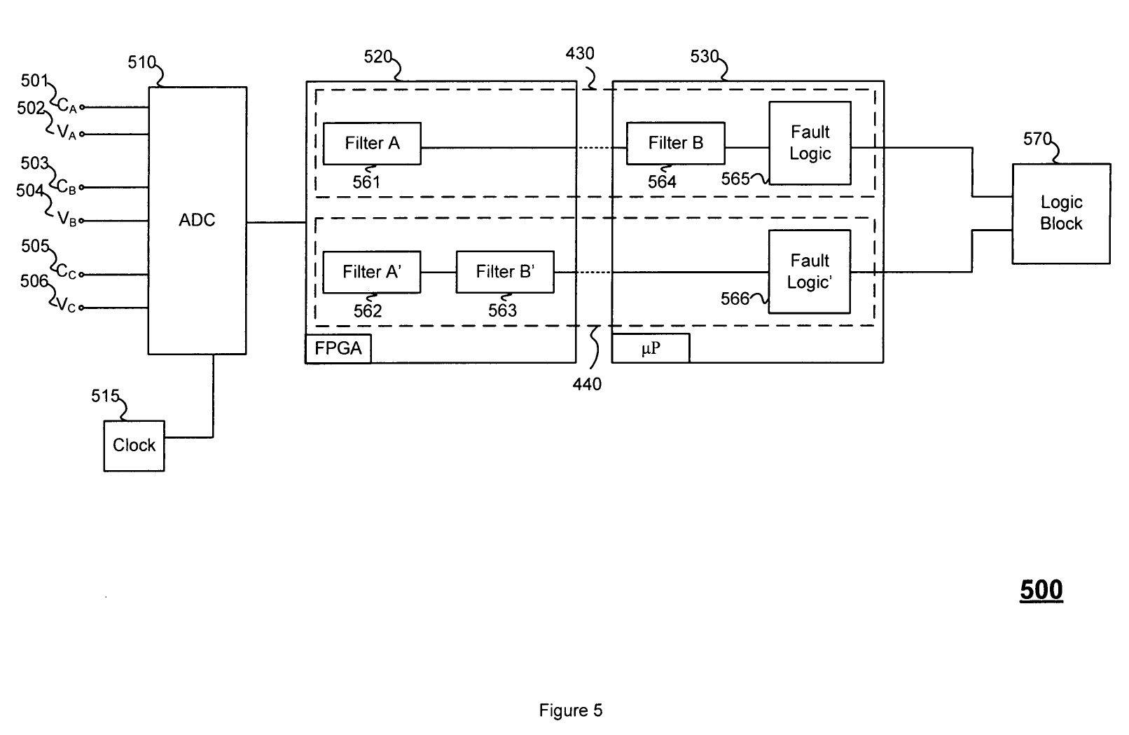

FIG. 5 shows one way in which logical processors may be split between physical processors utilizing the principles illustrated in FIG. 4. Three phases of current and voltage are acquired as analog signals 501-506 and converted into digital form by analog to digital converter 510, at a sampling rate set by clock 515. A field programmable gate array (FPGA) 520 (a physical processor) implements filter A 561, filter A′ 562, and filter B′ 563. Microprocessor 530 (a physical processor) implements filter B 564, fault logic 565, and fault logic′ 566. As illustrated, filter A 561, filter B 564, and fault logic 565 would comprise logical processor A 430 of FIG. 4. Correspondingly, filter A′ 562, filter B′ 563, and fault logic′ 566 would comprise logical processor B 440 of FIG. 4. Logic block 570 may be identical to logic block 445 of FIG. 4, and could be implemented as part of FPGA 520, microprocessor 530, or with a separate component. As drawn, logical processor A 430 and logical processor B 440 utilize identical algorithms. However, if they did not utilize identical algorithms, logic block 570 may be required to account for algorithm implementation differences.

In this embodiment fault logic 565 and fault logic′ 566 each separately calculate the magnitude of the signal. The logic block 570 then compares the magnitude difference against a fraction of the maximum value of the magnitudes. The fraction of the maximum value is determined based on the particular implementation. For example, if the two signal paths are processed with identical filters of identical numerical precision then the fraction can be small, increasing the sensitivity of the failure check. In one embodiment a value of 10% of the maximum value of the magnitudes can be chosen. If the comparison yields a value that exceeds the specified fraction of the maximum value of the magnitudes and the difference exceeds a minimum threshold, then the two signal paths are determined to be unequal due to a failure of either FPGA 520, microprocessor 530, or the device which implements logic block 570, which could be either FPGA 520 or microprocessor 530). In this case the intelligent electronic device is blocked from issuing a trip command to the power system. The minimum threshold is chosen to put a floor on the fraction of the maximum value of the magnitudes.

Note that the invention described herein utilizes a digital processor. As the algorithms described do not require any particular processing characteristics, any type of processor will suffice. For instance, microprocessors, microcontrollers, digital signal processors, field programmable gate arrays, application specific integrated circuits (ASIC) and other devices capable of digital computations are acceptable where the terms processor or computation engine are used.

Also note that the invention operates on line parameters of power conductors to detect faults using well known algorithms. Within the context of this patent, line parameters are defined as voltage and current.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

I claim:

1. A system for reliably detecting and isolating faults in a power conductor, the system comprising:
i) a disturbance detector, the disturbance detector coupled to the power conductor, the disturbance detector further monitoring the power conductor for faults, the disturbance detector being further coupled to a trip bus and operating to energize a trip bus when a fault is detected in the at least one power conductor; and
ii) at least one protective device, said protective device being coupled to the power conductor and monitoring the power conductor for faults separately from said disturbance detector, said protective device being coupled to the trip bus and operatively capable of opening the power conductor when the trip bus is energized and a fault is detected by the at least one protective device.

2. The system of claim 1 further comprising at least one circuit breaker, said circuit breaker being coupled to said power conductor and capable of interrupting the flow of current therein, said circuit breaker being responsively coupled to said protective device.

3. The system of claim 2 wherein said protective device is a protective relay.

4. A power system disturbance detector for detecting faults in a power conductor and for enabling the isolation of detected faults, the power system disturbance detector comprising:
i) at least one output adaptively coupled to a trip bus and energizing the trip bus when activated;
ii) sensory inputs for sensing at least one line parameter related to the power conductor;
iii) an analog to digital converter for converting the at least one line parameter to an at least one digital line parameter; and
iv) a processor coupled to said output and accepting the at least one digital line parameter and further analyzing the at least one digital line parameter and determining if a fault has occurred on said power conductor, and further activating said output on determination of the occurrence of said fault.

5. A method for reliably detecting and isolating faults in a power conductor comprising the steps of:
i) monitoring the power conductor for faults with a disturbance detector;
ii) energizing a trip bus with the disturbance detector when the disturbance detector detects a fault;
iii) monitoring the power conductor for faults with a power protection device capable of isolating faults in the power conductor; and
iv) isolating a fault detected by the power protection device only if the disturbance detector has energized the trip bus.

6. An intelligent electronic device for reliably detecting and isolating faults within a power conductor comprising:
i) an analog to digital converter for sampling at least one line parameter of the power conductor and producing a digital line parameter;
ii) a first logical processor coupled to the analog to digital converter and receiving the digital line parameter and executing a first fault detection algorithm to produce a first fault output;
iii) a second logical processor coupled to the analog to digital converter and receiving the digital line parameter and executing a second fault detection algorithm to produce a second fault output; and
iv) a logic block coupled to the first logical processor and the second logical processor, and receiving the first fault output and the second fault output and producing a trip output based on the first fault output and the second fault output.

7. The intelligent electronic device of claim 6, wherein the first logical processor is implemented within a first physical processor, and the second logical processor is implemented within a second physical processor.

8. The intelligent electronic device of claim 6, wherein the first logical processor and the second logical processor are implemented within a single physical processor.

9. The intelligent electronic device of claim 6, wherein the first logical processor is implemented at least partially on a first physical processor, and the second logic processor is implemented at least partially on a second physical processor.

10. The intelligent electronic device of claim 6, wherein the first fault detection algorithm is identical to the second fault detection algorithm.

11. A method for reliably detecting and isolating faults within a power conductor comprising the steps of:
i) sampling a line parameter and producing line parameter samples;
ii) analyzing the line parameter samples with a first logical processor and producing a first fault output;
iii) analyzing the line parameter samples with a second logical processor and producing a second fault output; and
iv) generating a trip output based on the first fault output and the second fault output.
